(19) United States
(12) Patent Application Publication
(10) Pub. No.: US 2017/0171502 A1
(43) Pub. Date: Jun. 15, 2017

(54) ELECTRONIC DEVICE AND METHOD FOR IMPLEMENTING SPLIT TELEVISION AND SPLIT TELEVISION

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Wen ZHANG, Tianjin (CN)

(21) Appl. No.: 15/250,533

(22) Filed: Aug. 29, 2016

Related U.S. Application Data
(63) Continuation of application No. PCT/CN2016/088736, filed on Jul. 5, 2016.

(30) Foreign Application Priority Data
Dec. 11, 2015 (CN) 201510924493.2

(51) Int. Cl. H04N 7/01; H04N 5/64; H04N 5/38

(52) U.S. Cl. CPC H04N 7/0117; H04N 5/38; H04N 7/0125; H04N 5/64; H04W 84/12

(57) ABSTRACT

An electronic device, a split television implementation method and a split television are disclosed. The split television implementation method includes: processing, by the processor, a received video signal, such that the video signal is converted into a first signal capable of being transmitted in a wireless manner; sending, by the processor, the first signal obtained via conversion to the playing device; acquiring, by the playing device, the first signal obtained via conversion; and processing, by the playing device, the acquired first signal, and converting the first signal into a video signal capable of being displayed on a display screen. The present disclosure further provides a split television, and the split television includes: a video signal processing module, configured to process a received video signal, such that the video signal is converted into a first signal; a sending module, configured to send the first signal to a playing device; an acquiring module, configured to acquire the first signal obtained via conversion; and a first signal processing module, configured to process the acquired first signal, and convert the first signal into a video signal capable of being displayed on a display screen. According to some embodiments of the present disclosure, aesthetica) shape of the split television is improved, and in addition, arrangement and space restrictions of the split television are also reduced.

### CROSS REFERENCE TO RELATED APPLICATIONS

This application is a continuation of International Application No. PCT/CN2016/088736 filed on Jul. 5, 2016, which is based upon and claims priority to Chinese Patent Application No. 201510924493.2, filed before Chinese Patent Office on Dec. 11, 2015 and entitled “ELECTRONIC DEVICE AND METHOD FOR IMPLEMENTING SPLIT TELEVISION AND SPLIT TELEVISION”, the entire contents of which are incorporated herein by reference.

### TECHNICAL FIELD

The present disclosure relates to the filed of video technologies, and more particularly, to a split television implementation method and a split television.

### BACKGROUND

With the improvement of people's living standards, split televisions are desired. For some split televisions, the television computer is separated from the screen, and a connection cable is used to connect the television computer and the screen; and for some split televisions, a display portion, a signal processing portion and a sound system of the television are separated from each other, and the television is composed by three parts: a television display terminal, a television computer, and a television speaker system.

The split television breaks through a structure mode of the traditional television that the television display terminal, the computer, and the television speaker system are integrated together, solves many problems that the traditional television cannot solve for a long time, greatly enhances service life, speaker effect, functional practicality of a tablet television, and historically implements personalized customization of the television. These three parts may be flexibly combined and upgraded, and in addition, the split television provides a necessary condition for the development of smart televisions.

However, no matter which type of split television, both the television computer and the display terminal thereof are connected via a cable, sometimes via a high-definition multimedia interface (HDMI) connection cable. The HDMI connection cable may transmit audio signals and video signals at the same time, and may transmit uncompressed high-definition video data and multi-channel audio data in high quality. By using only one signal cable, the audio data and the video data may be present on a high-definition television via a standard HDMI input interface. There are other solutions that the television computer of the split television is connected to the display of the split television via different connection cables.

During the implementation of the present disclosure, the inventors have found that the related art has at least the following problem: current solutions of a split television are almost that the split television transmits video signals output by the computer of the television by using a high-speed cable to a display screen, for example, using the high speed cable to transmit 4K high-definition signals output by the computer of the television to the display screen; the entire television is not beautiful; and restriction on the length of the connection cable subjects arrangement of the split television to some restrictions, and thus requirements are imposed on the space to be occupied by the split television. According to the solution of the split television in the related art, the split television is disadvantageous in the terms of aesthetical shape, arrangement, and the occupied space.

### SUMMARY

In view of the above, one of the technical problems to be solved in the present disclosure is to provide a split television implementation method and a split television, to solve the problem in the related art, improve aesthetical shape of the split television, and in addition, reduce arrangement and space restrictions of the split television.

Some embodiments of the present disclosure provides a split television implementation method, and the method includes the following steps performed by a processor and a playing device of the split television: processing, by the processor, a received video signal, such that the video signal is converted into a first signal capable of being transmitted in a wireless manner; sending, by the processor, the first signal obtained via conversion to the playing device; acquiring, by the playing device, the first signal obtained via conversion; and processing, by the playing device, the acquired first signal, and converting the first signal into a video signal capable of being displayed on a display screen.

Some embodiments of the present disclosure further provides a split television, and the split television includes: a video signal processing module, configured to process a received video signal, such that the video signal is converted into a first signal capable of being transmitted in a wireless manner; a sending module, configured to send the first signal obtained via conversion by the video signal processing module to a playing device in a wireless transmission manner; an acquiring module, configured to acquire the first signal obtained via conversion by the video signal processing module, sent by the sending module in the wireless transmission manner; and a first signal processing module, configured to process the first signal acquired by the acquiring module, and convert the first signal into a video signal capable of being displayed on a display screen.

Some embodiments of the present disclosure further provides an electronic device, and the electronic device includes at least one processor; and a memory; wherein the memory stores instructions executable by the at least one processor, wherein, the instructions, when being executed by the at least one processor, cause the at least one processor to perform any one of the split television implementation method as defined in the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a split television implementation method according to some embodiments of the present disclosure;

FIG. 2 is a flowchart illustrating a split television implementation method according to some embodiments of the present disclosure;

FIG. 3 is a flowchart illustrating a split television implementation method according to some embodiments of the present disclosure;

FIG. 4 is a flowchart illustrating a split television implementation method according to some embodiments of the present disclosure;

FIG. 5 is a schematic structural diagram illustrating a split television according to some embodiments of the present disclosure;

FIG. 6 is a schematic structural diagram illustrating a split television according to some embodiments of the present disclosure;

FIG. 7 is a schematic structural diagram illustrating a split television according to some embodiments of the present disclosure;

FIG. 8 is a schematic structural diagram illustrating a split television device according to some embodiments of the present disclosure;

FIG. 9 is a schematic structural diagram illustrating a split television device according to some embodiments of the present disclosure; and

FIG. 10 is a schematic structural diagram illustrating hardware of an electronic device for performing a split television implementation method according to some embodiments of the present disclosure.

### DETAILED DESCRIPTION

In the present disclosure, a video signal is converted into a first signal capable of being transmitted in a wireless manner, such that the first signal is transmitted between a processor and a playing device to the playing device; and subsequently the first signal is converted into a first signal capable of being displayed on a display screen, such that a fluent play of the video signal may be implemented with no need of a connection cable between the processor and the displaying device of a split television. This improves the aesthetical shape of the split television, and in addition, reduces arrangement and space restrictions of the split television.

Nevertheless, it is not necessary to require that any technical solution according to the embodiments of the present disclosure achieves all of the above technical effects.

To make a person skilled in the art better understand the technical solutions of the embodiments of the present disclosure, the technical solutions of the present disclosure are clearly and completely described with reference to the accompanying drawings of the embodiments of the present disclosure. Apparently, the described embodiments are only a part of the embodiments of the present disclosure, rather than the entire embodiments. Based on the embodiments of the present disclosure, all other embodiments derived by a person of ordinary skill in the art shall fall within the protection scope of the present disclosure.

Specific implementations of the embodiments of the present disclosure are further described hereinafter with reference to the accompanying drawings of the present disclosure.

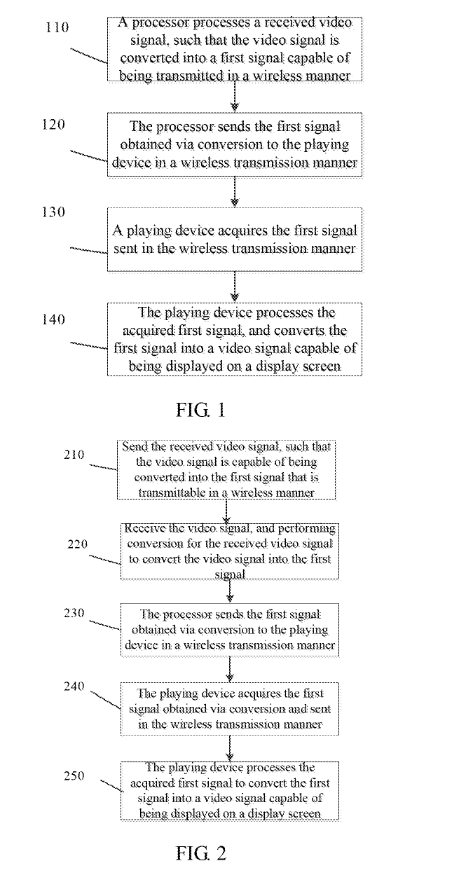

FIG. 1 is a flowchart illustrating a split television implementation method according to some embodiments of the present disclosure. As illustrated in FIG. 1, the embodiment of the present disclosure includes the following steps performed by a processor and a playing device of a split television:

Step 110: A processor processes a video signal, such that the video signal is converted into a first signal capable of being transmitted in a wireless manner.

The processor of the split television receives a video signal from an external device. Specifically, the television receives a variety of signals, for example, television signals, or signals from the Internet and the like. The television signals include, for example, television signals input via an optical fiber, television signal from satellites and the like. The external device of the television may also be an important source of the received signals, and more and more external devices are connected to the television, for example, digital camera, digital video recorder, stream medium player, cameras, MP3, mobile hard disk, U disk, motion sensing game receiver and the like.

Upon receiving the external video signals, the processor of the split television converts the video signals into the first signals capable of being transmitted in the wireless manner. It may be understood that the first signal in the related art includes a Bluetooth, a microwave, an infrared, a wireless local area network (WLAN), or the like.

The processor of the split television may convert the received external video signal into, for example, a first signal in a Bluetooth format, in a microwave format, or in an infrared format, or convert the received external video signal into a wireless data signal supported by a WLAN format.

Using a WLAN as an example, the WLAN is the network created in a certain local range by using a wireless communication technology, and is a product by combining of a computer network and a wireless communication technology; uses a wireless multi-address channel as a transmission medium, and provides a function of a traditional wired local area network (LAN), which is capable of enabling a user to access a broadband network anywhere anytime at his or her will.

The 802.11ad protocol is a wireless LAN protocol of the institute of electrical and electronics engineers (IEEE), and may be applied to a switched Ethernet environment and a shared network environment with no need of a multilayer encapsulation between the protocols, such that unnecessary overhead and redundancy are removed, and the disclosure is flexible. In the embodiment of the present disclosure, the method may be implemented based on the technology complying with the 802.11 protocol, or based on other existing or future wireless technologies. For ease of description, the embodiment of the present disclosure uses the wireless technology complying with the 802.11 ad protocol as an example.

In step 110, the processor processes the received video signal, such that the video signal is converted into the first signal, for example, a wireless technology complying with the 802.11ad protocol. A conversion method may use a method that the video signal in an existing various formats is converted into the first signal capable of being transmitted in the wireless manner, which is not limited in the embodiment of the present disclosure.

Step 120: The processor sends the first signal obtained via conversion to the playing device in a wireless transmission manner.

In this step, the processor of the split television sends the first signal obtained via conversion in step 110 to the playing device of the split television in the wireless transmission manner. For example, the first signal is transmitted via a frequency band and a communication mode that are supported by the 802.11ad protocol. It may be understood that a corresponding wireless interface is required for performing this step.

For example, the 802.11ad protocol is a high-speed WLAN protocol, and uses a 60 GHz frequency band. The highest rate is 7 Gb/s, and a practical rate is 1 Gb/s. For another example, at present, the most popular WLAN protocol uses a 2.4 GHz frequency band. The highest rate is 11 Gb/s, the practical rate is variable according to the distance and the signal strength: and generally, the practical rate is 1-2 Mb/s within 150 meters and is 11 Mb/s within 50 meters. The usage cost of a wireless data network with a lower rate using the 802.11b protocol is affordable by people. Compatibility between devices using the 802.11b protocol is powerful. In the embodiment of the present disclosure, the first signal may also be transmitted by using the 802.11b protocol, which is not limited in the embodiment of the present disclosure.

Step 130: The playing device acquires the first signal obtained via conversion and sent in the wireless transmission manner.

In this step, the playing device receives data sent in step 120 via a wireless interface corresponding to the wireless interface used in step 120, and the data is wireless data obtained via conversion by the video signal and acquired by the processor of the split television. The wireless data may be converted into the video signal to play on the playing device.

Step 140: The playing device processes the acquired first signal to convert the first signal into a video signal capable of being displayed on a display screen.

The playing device processes the first signal obtained via conversion by the video signal to convert the first signal into the video signal. Specifically, when the first signal is converted into the video signal, the first signal may be converted according to a format of the video signal which is capable of being played by the playing device. The conversion may be performed according to different resolutions, and different formats. For example, when the playing device is a liquid crystal screen, the first signal may be converted into a V-by-One signal. A V-by-One interface is mainly used in the aspects of large screen display and camera security. The V-by-One interface is to transmit a low voltage differential small computer system interface signaling (LVDS), or a transistor-transistor logic (TTL) signal. Generally, printed circuit board (PCB) wiring is reduced, and thus the V-by-One interface is especially used on a large screen. Nevertheless, the first signal is converted into the video signal in other formats according to a format of the video signal which is capable of being played by the playing device, which is not limited in the embodiment of the present disclosure.

In the embodiment of the present disclosure, a video signal is converted into a first signal, such that the first signal is transmitted from a processor to a playing device; and subsequently the first signal is converted into a video signal capable of being displayed on a display screen, such that a fluent play of the video signal may be implemented with no need of a connection cable between the processor and the displaying device of a split television. This improves the aesthetica) shape of the split television, and in addition, reduces arrangement and space restrictions of the split television.

FIG. 2 is a flowchart illustrating a split television implementation method according to some embodiments of the present disclosure. As illustrated in FIG. 2, some embodiments of the present disclosure includes the following steps performed by a processor and a playing device of a split television.

Step 210: A received video signal is sent, such that the video signal is capable of being converted into a first signal.

In the embodiment of the present disclosure, the processor of the split television sends the received video signal to a chip capable of performing conversion for the video signal, such that the video signal in the chip is capable of being converted into the first signal that is transmittable in a wireless manner.

Step 220: The video signal is received, and conversion for the video signal is performed to convert the video signal into the first signal.

In this step, conversion for the video signal sent in step 210 is performed to convert the video signal into the first signal that is transmittable in the wireless manner The first signal may be a first signal in any format in the related art. It may be understood that the related art may be used to convert the video signal into the first signal, and multiple such selections exist in the related art, which is not limited in the embodiment of the present disclosure.

Step 230: The processor sends the first signal obtained via conversion to the playing device in a wireless transmission manner.

In this step, the processor of the split television sends the first signal obtained via conversion in step 220 to the playing device of the split television in the wireless transmission manner. The specific operation may refer to step 120 in the embodiment corresponding to FIG. 1.

Step 240: The playing device acquires the first signal obtained via conversion and sent in the wireless transmission manner.

In this step, the playing device receives data sent in step 230 via a wireless interface corresponding to the wireless interface used in step 230, and the data is wireless data obtained via conversion by the video signal and acquired by the processor of the split television. The wireless data may be converted into the video signal to play on the playing device. The specific operation may refer to step 130 in the embodiment corresponding to FIG. 1.

Step 250: The playing device processes the acquired first signal to convert the first signal into a video signal capable of being displayed on a display screen.

In this step, the playing device processes the first signal obtained via conversion by the video signal to convert the first signal into the video signal. The specific operation may refer to step 140 in the embodiment corresponding to FIG. 1.

In the embodiment of the present disclosure, a video signal is converted into a first signal, such that the first signal is transmitted between a processor and a playing device; and subsequently the first signal is converted into a video signal capable of being displayed on a display screen, such that a fluent play of the video signal may be implemented with no need of a connection cable between the processor and the playing device of a split television. This improves the aesthetical shape of the split television.

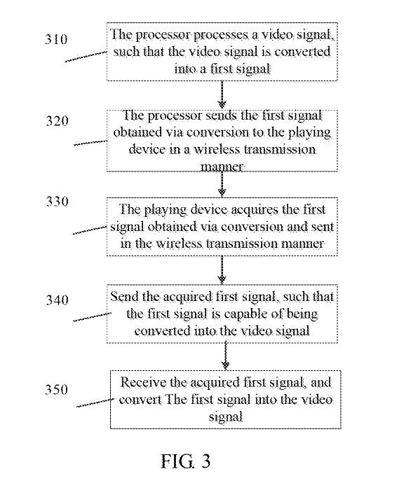

FIG. 3 is a flowchart illustrating a split television implementation method according to some embodiments of the present disclosure. As illustrated in FIG. 3, some embodiments of the present disclosure includes the following steps performed by a processor and a playing device of a split television.

Step 310: The processor processes a video signal, such that the video signal is converted into a first signal.

Upon receiving the external video signals, the processor of the split television converts the video signals into the first signals capable of being transmitted in the wireless manner. It may be understood that the first signal in the related art includes a Bluetooth, a microwave, an infrared, a wireless local area network (WLAN), or the like.

In Step 310, the processor processes the received video signal, such that the video signal is converted into the first signal, for example, a wireless technology complying with the 802.11ad protocol. The video signal is converted into the first signal by using the method that video signals in existing various formats are converted into the first signals in the related art, which is not limited in the embodiment of the present disclosure.

Step 320: The processor sends the first signal obtained via conversion to the playing device in a wireless transmission manner.

In this step, the processor of the split television sends the first signal obtained via conversion in step 310 to the playing device of the split television in the wireless transmission manner. For example, the first signal is transmitted via a frequency band and a communication mode that are supported by the 802.11ad protocol. It may be understood that a corresponding wireless interface is required for performing this step.

Step 330: The playing device acquires the first signal obtained via conversion and sent in the wireless transmission manner.

In this step, the playing device receives data sent in step 320 via a wireless interface corresponding to the wireless interface used in step 320, and the data is wireless data obtained via conversion by the video signal and acquired by the processor of the split television. The wireless data may be converted into the video signal to play on the playing device.

Step 340: The acquired first signal is sent, such that the first signal is capable of being converted into the video signal.

In this step, the acquired first signal obtained via conversion by the video signal is sent, such that the first signal is capable of being converted into the video signal. It may be understood that such conversion method may be any of the methods that the first signal obtained via conversion by the video signal is converted into the video signal in the related art, which is not limited in the embodiment of the present disclosure.

Step 350: The acquired first signal is received, and conversion for the first signal is performed to convert the first signal into the video signal. In this step, the first signal is received, and conversion for the first signal is performed to convert the first signal into the video signal. A specific conversion method may be implemented according to the related art, an operation of this step may refer to step 140 in the embodiment corresponding to FIG. 1.

In the embodiment of the present disclosure, a video signal is converted into a first signal, such that the first signal is transmitted between a processor and a playing device to the playing device; and subsequently the first signal is converted into a first signal capable of being displayed on a display screen, such that a fluent play of the video signal may be implemented with no need of a connection cable between the processor and the displaying device of a split television. This improves the aesthetical shape of the split television, and in addition, reduces arrangement and space restrictions of the split television.

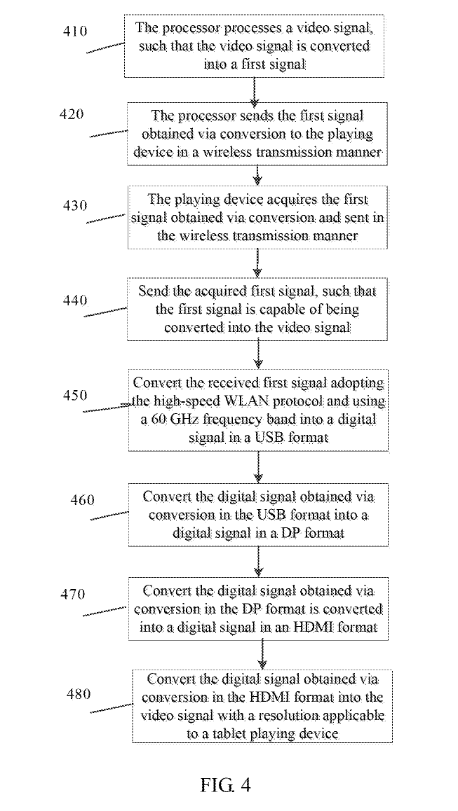

FIG. 4 is a flowchart illustrating a split television implementation method according to some embodiments of the present disclosure. As illustrated in FIG. 4, some embodiments of the present disclosure includes the following steps performed by a processor and a playing device of the split television.

Step 410: The processor processes a video signal, such that the video signal is converted into a first signal.

Upon receiving the external video signals, the processor of the split television converts the video signals into the first signals capable of being transmitted in the wireless manner It may be understood that the first signal in the related art includes a Bluetooth, a microwave, an infrared, a wireless local area network (WLAN), or the like.

Step 420: The processor sends the first signal obtained via conversion to the playing device in a wireless transmission manner.

In this step, the processor of the split television sends the first signal obtained via conversion in step 410 to the playing device of the split television in the wireless transmission manner. For example, the first signal is transmitted via a frequency band and a communication mode that are supported by the 802.11ad protocol. It may be understood that a corresponding wireless interface is required for performing this step.

Step 430: The playing device acquires the first signal obtained via conversion and sent in the wireless transmission manner.

In this step, the playing device receives data sent in step 420 via a wireless interface corresponding to the wireless interface used in step 420, and the data is wireless data obtained via conversion by the video signal and acquired by the processor of the split television. The wireless data may be converted into the video signal to play on the playing device.

Step 440: The acquired first signal is sent, such that the first signal is capable of being converted into the video signal.

In this step, the acquired first signal obtained via conversion by the video signal is sent, such that the first signal is capable of being converted into the video signal. It may be understood that such conversion method may be any of the methods that the first signal obtained via conversion by the video signal is converted into the video signal in the related art, which is not limited in the embodiment of the present disclosure.

Step 450: The received first signal adopting the high-speed WLAN protocol and using a 60 GHz frequency band is converted into a digital signal in a universal serial bus (USB) format.

The meaning of the USB is the universal serial bus, and the USB is an interface specification officially applied on such products as a computer, a digital camera, a tablet television or the like.

USB1.0 appeared in 1996, and the transmission speed of USB1.0 was only 1.5 Mb/s; and USB1.0 was upgraded to USB 1.1 in 1998, and the transmission speed of USB1.1 was greatly enhanced to 12 Mb/s. USB1.1 is a general USB specification, and the transmission rate of USB1.1 in a high-speed manner is 12 Mb/s, and 1.5 Mb/s in a low-speed manner. USB2.0 specification is evolved from the USB1.1 specification. The transmission rate of USB2.0 reaches 480 Mbps, and conversion of 480 Mb/s into MB is 60 MB/s, which sufficiently satisfies the rate requirements imposed by most external devices. An “enhanced host controller interface (EHCI)” in USB2.0 defines an architecture compatible with the USB2.2. Under this architecture, all USB1.1 devices may be driven by the drive program of USB2.0. All devices supporting USB1.1 may be directly used on an interface of the USB 2.0 with no need of considering the problem of compatibility, and in addition, such accessories as a USB cable, a plug, or the like may also be directly used on the interface of USB2.0. A new-generation USB3.0 standard has been officially completed and publicly released. The theoretical speed of USB3.0 is 5.0 Gb/s, but the practical speed is only 50% of the theoretical anticipation, that is, 10 times of the speed of USB2.0. The physical layer of USB3.0 uses 8b/10b coding, which may be widely used in external devices of the PC, and consumer electronics.

The USB interface is an extremely commonly-used interface, and data supported by the USB format in this step may be any one of USB standards. In the related art, a plurality of methods for converting data in a USB format into data in another format, and for converting data in another format into data in a USB format may be applied to this step. In this step, the received first signal adopting the high-speed WLAN protocol and using a 60 GHz frequency band is converted into a digital signal in a USB format.

Step 460: The digital signal obtained via conversion in the USB format is converted into a digital signal in a display port (DP) format.

A display port (DP) interface is a high-definition audio and video stream transmission interface, and allows audio and video signals to share one cable for transmission. In this step, the digital signal obtained via conversion in a USB format is converted into the digital signal in a DP format.

Step 470: The digital signal obtained via conversion in the DP format is converted into a digital signal in a high-definition multimedia interface (HDMI) format.

A high-definition multimedia interface (hereinafter referred to as HDMI) may transmit an audio and the video signal at the same time, and may transmit an uncompressed high-definition video data and multi-channel audio data in a high quality. For a mobile high-definition link (MHL), only one piece of signal cable is used, the audio data and video data may be presented on a high-definition television via a standard HDMI interface. In this step, the digital signal obtained via conversion in a DP format is converted into the digital signal in an HDMI format. In the related art, a plurality of methods for converting data in a DP format into data in HDMI format may be applied to this step, which is not limited in the embodiment of the present disclosure.

Step 480: The digital signal obtained via conversion in the HDMI format is converted into the video signal with a resolution applicable to a tablet playing device.

In this step, the digital signal obtained via conversion in the HDMI format is converted into the video signal with a resolution applicable to a tablet playing device, for example, converted into a V-by-One ultra-high-definition display format, or converted into 4K or 2K ultra-high-definition displaying format, or other formats.

In the embodiment of the present disclosure, a video signal is converted into a first signal, such that the first signal is transmitted between a processor and a playing device to the playing device, and subsequently the first signal is converted via USB-DP-HDMI-4K high definition or the like, which implements an authentic split television, in addition, enables the video signal to be clearly played on a large screen, and improves user experience.

Specifically, in the embodiment corresponding to FIG. 1 to FIG. 4, the performing conversion for the received video signal, and converting the video signal into the first signal specifically includes: converting the received first signal with the resolution of 4K or 2K into the first signal adopting the high-speed WLAN protocol and using a 60 GHz frequency band.

More specifically, in the embodiment corresponding to FIG. 1 to FIG. 4, the performing conversion for the acquired first signal, and converting the first signal into the video signal specifically includes: converting the received first signal adopting the high-speed WLAN protocol and using a 60 GHz frequency band into the video signal with the resolution of 4K or 2K.

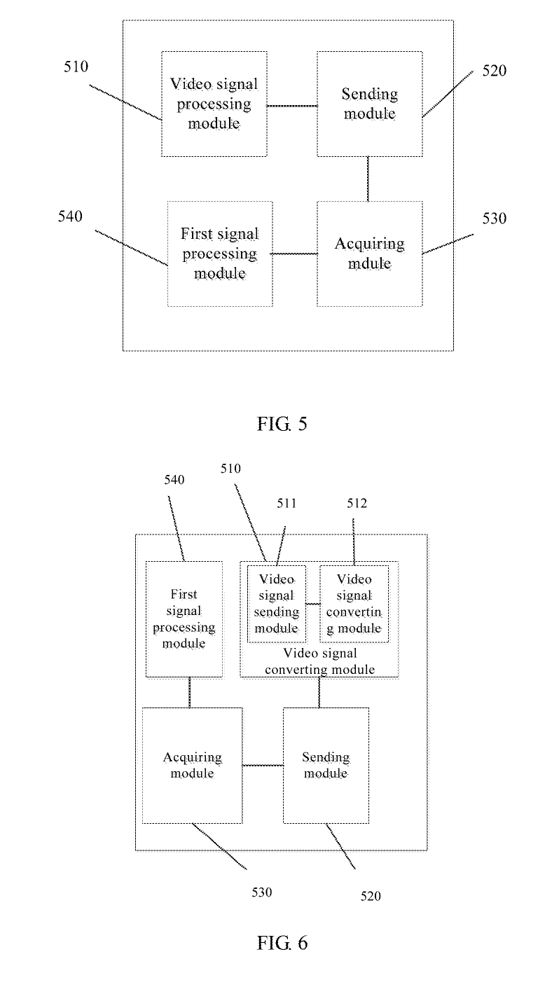

FIG. 5 is a schematic structural diagram illustrating a split television according to some embodiments of the present disclosure. As illustrated in FIG. 5, the split television includes: a video signal processing module 510, a sending module 520, an acquiring module 530 and a first signal processing module 540.

A video signal processing module 510 is configured to process a video signal, such that the video signal is converted into a first signal capable of being transmitted in a wireless manner.

After a processor of the split television receives the external video signals, the video signal processing module 510 converts the video signals into the first signals capable of being transmitted in the wireless manner. It may be understood that the first signal in the related art includes a Bluetooth, a microwave, an infrared, a wireless local area network (WLAN), or the like. In this embodiment, using 802.11ad protocol wireless technology as an example, the video signal processing module 510 converts the received video signal into the first signal of the wireless technology complying with the 802.11ad protocol.

Specific operations performed by the video signal processing module 510 may refer to step 110 in the embodiment corresponding to FIG. 1.

The sending module 520 is configured to send the first signal obtained via conversion by the video signal processing module 510 to a playing device in a wireless transmission manner.

Specifically, the sending module 520 sends the first signal obtained via conversion by the video signal processing module 510 to the playing device of the split television in the wireless transmission manner. For example, the first signal is transmitted via a frequency band and a communication mode that are supported by the 802.11ad protocol. It may be understood that a corresponding wireless interface is required for performing this step.

Specific operations performed by the sending module 520 may refer to step 120 in the embodiment corresponding to FIG. 1.

The acquiring module 530 is configured to acquire the first signal obtained via conversion by the video signal processing module 510, sent by the sending module in the wireless transmission manner.

Specifically, the acquiring module 530 receives data sent by the sending module 520 via a wireless interface corresponding to a wireless interface used by the sending module 520, and the data is wireless data obtained via conversion of the video signal acquired by the processor of the split television. The wireless data may be converted into the video signal to play on the playing device.

Specific operations performed by the acquiring module 530 may refer to step 130 in the embodiment corresponding to FIG. 1.

The first signal processing module 540 is configured to process the first signal acquired by the acquiring module, and convert the first signal into a video signal capable of being displayed on a display screen.

Specifically, the first signal processing module 540 processes the first signal acquired by the acquiring module 530, and converts the first signal into the video signal. Specifically, when the first signal is converted into the video signal, the first signal may be converted according to a format of the video signal which is capable of being played by the playing device. The conversion may be performed according to different resolutions, and different formats. For example, when the playing device is a liquid crystal screen, the first signal may be converted into a V-by-One signal. Nevertheless, the first signal is converted into the video signal in other formats according to the format of the video signal which is capable of being played by the playing device, which is not limited in the embodiment of the present disclosure.

Specific operations performed by the first signal processing module 540 may refer to step 140 in the embodiment corresponding to FIG. 1.

In the embodiment of the present disclosure, a video signal processing module 510 converts a video signal into a first signal, a sending module sends the first signal to an acquiring module of a playing device, and after the acquiring module of the playing device acquires the first signal obtained via conversion, the first signal processing module 540 converts the first signal into a video signal capable of being displayed by the playing device, such that a wireless connection between the computer and the display of a split television is implemented. This improves the aesthetical shape of the split television, and in addition, reduces arrangement and space restrictions of the split television.

FIG. 6 is a schematic structural diagram illustrating a split television according to some embodiments of the present disclosure. As illustrated in FIG. 6, the split television in the embodiment of the present disclosure includes: a video signal processing module 510, a sending module 520, an acquiring module 530 and a first signal processing module 540, wherein specific operations of the sending module 520, the acquiring module 530, and the first signal processing module 540 may refer to each module in the embodiment corresponding to FIG. 5. The video signal processing module 510 specifically includes a video signal sending module 511 and a video signal converting module 512.

The video signal sending module 511 is configured to send a received video signal, such that a video signal is capable of being converted into a first signal.

Specifically, the video signal sending module 511 sends the received video signal to a chip capable of performing conversion for the video signal, such that the video signal in the chip is capable of being converted into the first signal.

Specific operations performed by the video signal sending module 511 may refer to step 210 in the embodiment corresponding to FIG. 2.

The video signal converting module 512 is configured to receive the video signal sent by the video signal sending module 511, and perform conversion for the received video signal to convert the video signal into the first signal.

Specifically, the video signal converting module 512 performs conversion for the video signal sent by the video signal sending module 511 to convert the video signal into the first signal that is transmittable via a wireless interface. The first signal may be a first signal in any format in the related art. It may be understood that the related art may be used to convert the video signal into the first signal, and multiple such selections exist in the related art, which is not limited in the embodiment of the present disclosure.

Specific operations performed by the video signal sending module 511 may refer to step 220 in the embodiment corresponding to FIG. 2.

In the embodiment of the present disclosure, a video signal is converted into a first signal, such that the first signal is transmitted between a processor and a playing device to the playing device; and subsequently the first signal is converted into a first signal capable of being displayed on a display screen, such that a fluent play of the video signal may be implemented with no need of a connection cable between the computer and the display of a split television. This improves the aesthetical shape of the split television.

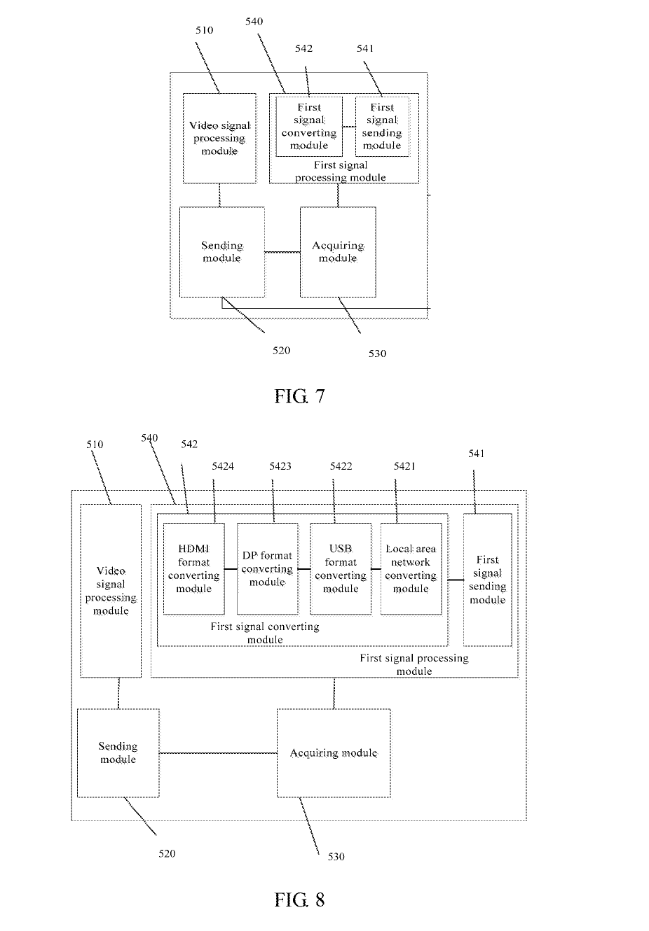

FIG. 7 is a schematic structural diagram illustrating a split television according to some embodiments of the present disclosure. As illustrated in FIG. 7, the split television in the embodiment of the present disclosure includes: a video signal processing module 510, a sending module 520, an acquiring module 530 and a first signal processing module 540, wherein specific operations of the video signal processing module 510, the sending module 520 and acquiring module 530 may refer to each module in the embodiment corresponding to FIG. 5. The first signal processing module 540 specifically includes a first signal sensing module 541 and a first signal converting module 542.

The first signal sending module 541 is configured to send the first signal acquired by the acquiring module 530, such that the first signal is capable of being converted into the video signal.

Specifically, the first signal sending module 541 sends the first signal which is converted by the video signal, acquired by the acquiring module 530, such that the first signal is capable of being converted into the video signal.

Specific operations performed by the first signal sending module 541 may refer to step 340 in the embodiment corresponding to FIG. 3.

The first signal converting module 542 is configured to receive the first signal sent by the first signal sending module 541, and perform conversion for the first signal to convert the first signal into the video signal.

Specifically, the first signal converting module 542 receives the first signal sent by the first signal sending module 541, and performs conversion for the first signal to convert the first signal into the video signal. Specific conversions may be implemented according to the related art, which is not limited in the embodiment of the present disclosure.

Specific operations performed by the first signal sending module 542 may refer to step 350 in the embodiment corresponding to FIG. 3.

In the embodiment of the present disclosure, a video signal is converted into a first signal, such that the first signal is transmitted between a processor and a playing device to the playing device; and subsequently the first signal is converted into a first signal capable of being displayed on a display screen, such that a fluent play of the video signal may be implemented with no need of a connection cable between the computer and the display of a split television. This improves the aesthetica) shape of the split television.

FIG. 8 is a schematic structural diagram illustrating a split television device according to the present disclosure. As illustrated in FIG. 8, the split television in the embodiment of the present disclosure includes: a video signal processing module 510, a sending module 520, an acquiring module 530, a first signal processing module 540, wherein specific operations of the video signal processing module 510, the sending module 520 and acquiring module 530 may refer to each module in the embodiment corresponding to FIG. 7, the first signal processing module 540 specifically includes a first signal sending module 541 and a first signal converting module 542, and the specific operations of the first signal processing module 540 may refer to the embodiment corresponding to FIG. 7.

The first signal converting module 542 includes: a local area network converting module 5421, a USB format converting module 5422, a DP format converting module 5423, and an HDMI format converting module 5424.

The local area network converting module 5421 is configured to convert the first signal adopting the high-speed wireless local area network (WLAN) protocol and using a 60 GHz frequency band, received by the video signal sending module, into a digital signal in a universal serial bus (USB) format.

A USB interface is an extremely commonly-used interface, and data supported by the USB format in the embodiment of the present disclosure may be any one of USB standards. In the related art, a plurality of methods for converting data in a USB format into data in another format, and for converting data in another format into data in a USB format may be applied to this step. Specifically, the local area network converting module 5421 converts the received first signal adopting the high-speed WLAN protocol and using the 60 GHz frequency band into the digital signal in the USB format.

Specific operations performed by the local area network converting module 5421 may refer to step 450 in the embodiment corresponding to FIG. 4.

The USB format converting module 5422 is configured to convert the digital signal obtained via conversion by the local area network convening module in a USB format into a digital signal in a display port (DP) format.

A display port (DP) interface is a high-definition audio and video stream transmission interface, and allows audio and video signals to share one cable for transmission. Specifically, the USB format converting module 5422 converts the digital signal in the USB format obtained via conversion into the digital signal in the DP format.

Specific operations performed by the USB format converting module 5422 may refer to step 460 in the embodiment corresponding to FIG. 4.

The DP format converting module 5423 is configured to convert the digital signal obtained via conversion by the USB format converting module 5422 in the DP format into a digital signal in a high-definition multimedia interface (HDMI) format.

The high-definition multimedia interface (hereinafter referred to as HDMI) may transmit an audio signal and a video signal at the same time, and may transmit an uncompressed high-definition video data and multi-channel audio data in high quality. For a mobile high-definition link (MHL), only one piece of signal cable is used, the audio data and video data may be presented on a high-definition television via a standard HDMI interface. Specifically, the DP format convening module 5423 converts the digital signal obtained via conversion in the DP format into the digital signal in the HDMI format.

Specific operations performed by the DP format converting module 5423 may refer to step 470 in the embodiment corresponding to FIG. 4.

The HDMI format converting module 5424 is configured to convert the digital signal in the HDMI format converted by the DP format convening module 5423 into the video signal of a tablet playing device.

Specifically, the HDMI format converting module 5424 converts the digital signal obtained via conversion in the HDMI format is converted into the video signal with a resolution of 4K or 2K, for example, converted into a V-by-One ultra-high-definition displaying format, or converted into 4K or 2K ultra-high-definition displaying format, or other formats.

Specific operations performed by the HDMI format converting module 5424 may refer to step 480 in the embodiment corresponding to FIG. 4.

In the embodiment of the present disclosure, a video signal is converted into a first signal, such that the first signal is transmitted between a processor and a playing device to the playing device, and subsequently the first signal is converted via a USB-DP-HDMI-4K high-definition or the like, which implements a real split television, in addition, enables the video signal to be clearly played on a big screen, and improves user experience.

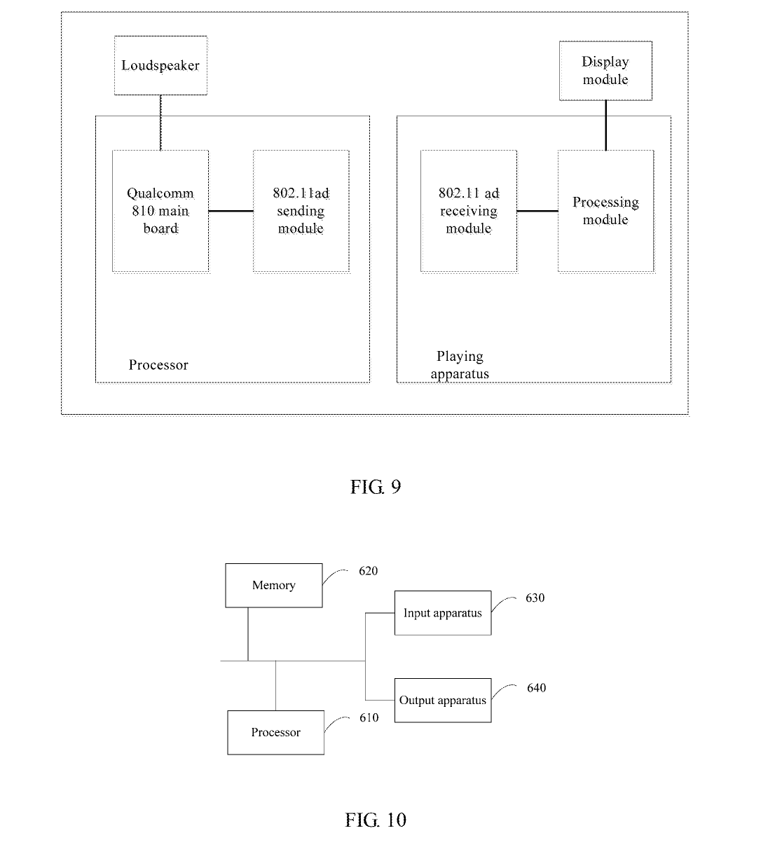

FIG. 9 is a schematic structural diagram illustrating a split television device according to some embodiments of the present disclosure. As illustrated in FIG. 9, the split television includes a computer processor and a playing device.

The processor includes a Qualcomm 810 main board and an 820.11ad sending module. The 810 main board is a core processing element, and is responsible for processing man-machine interaction interfaces including high-definition signals of network videos and external inputs, and network games; and in addition, the 810 main board outputs 4K or 2K high-definition signals in the HDMI format or in another format to the 820.11ad sending module. The 820.11ad sending module is a module complying with the 820.11ad protocol, and is responsible for converting the 4K or 2K high-definition signals sent by the computer into the signals transmitted in the wireless manner and using a 60 GHz frequency band.

The playing device includes an 820.11ad receiving module and a processing module, wherein the 820.11ad receiving module receives the signals sent by the 802.11ad sending module at the processor end in the wireless manner within 60 GHz frequency band, and sends the signals to the processing module via a peripheral component interface express (PCIE) interface. The processing module processes the signal sent by the 820.11ad receiving module and converts the signal into the V-by-One signal that may be received and processed by the display screen for display on a liquid crystal display.

In addition, the playing apparatus further includes a display module, and the liquid crystal display system finally displays signals having a resolution of 4K or 2K, thereby implementing the man-machine interaction interface and displaying the images.

In the embodiment of the present disclosure, the processor and the playing apparatus of the split television employ the 820.11ad module, and convert the received video signals into signals that may be wirelessly transmitted by using the 820.11ad protocol, such that the processor and the playing apparatus of the split television do not need a physical connection cable. This not only beautifies the split television, but also brings more freedom for arrangement of the split television in terms of space, thereby improving user experience.

FIG. 10 is a schematic structural diagram illustrating hardware of an electronic device for performing a split television implementation method according to some embodiments of the present disclosure.

As illustrated in FIG. 10, the electronic device includes: at least one processor 610 and a memory 620, and FIG. 10 uses one processor 610 as an example.

The electronic device for performing the split television implementation method may include: an input device 630 and a playing device 640.

The processor 610, the memory 620, the input device 630, and the playing device 640 may be connected via a bus or in another manner, and FIG. 10 uses connection via a bus as an example.

The memory 620 is a nonvolatile computer readable storage medium, and may be used to store nonvolatile software programs, nonvolatile computer executable programs and modules, such as program instructions/modules corresponding to the split television implementation method in the embodiments of the present disclosure. The processor 610 executes various function disclosures and data processing of a server by means of running the nonvolatile software programs, the programs and modules stored in the memory 620, that is, the processor 610 implements the split television implementation method in above method embodiment.

The memory 620 may include a program memory area and data memory area, wherein the program memory area may store operation systems and disclosure programs needed by at least function; and the data memory area may store data created according to the usage of the split television. In addition, the memory 620 may include a high speed random access memory, or include a non-volatile memory, for example, at least one disk storage device, a flash memory device, or another non-volatile solid storage device. In some embodiments, the memory 620 optionally includes the memory remotely arranged relative to the processor 610, and such remote memory may be connected to the split television over the network. The above examples include, but not limited to, the Internet, Intranet, local area network, mobile communication network and a combination thereof.

The input device 630 may receive an input numeric or character information, and generate key signal inputs related to function control and user setting of the split television. The playing device 640 may include a display device such as a display screen.

One or more modules are stored in the memory 620, wherein the one or more modules, when being executed by the at least one processor 610, perform the split television implementation method in any one of the method embodiments.

The product may perform the method according to the embodiments of the present disclosure, has corresponding function modules for performing the method, and achieves the corresponding beneficial effects. For technical details that are not illustrated in detail in this embodiment, reference may be made to the description of the methods according to the embodiments of the present disclosure.

The electronic device in the embodiments of the present disclosure is practiced in various forms, including, but not limited to:

(1) a mobile communication device: which has the mobile communication function and is intended to provide mainly voice and data communications; such terminals include: a smart phone (for example, an iPhone), a multimedia mobile phone, a functional mobile phone, a low-end mobile phone and the like;

(2) an ultra mobile personal computer device: which pertains to the category of personal computers and has the computing and processing functions, and additionally has the mobile Internet access feature; such terminals include: a PDA, an MID, an UMPC device and the like, for example, an iPad;

(3) a portable entertainment device: which displays and plays multimedia content; such devices include: an audio or video player (for example, an iPod), a palm game machine, an electronic book, and a smart toy, and a portable vehicle-mounted navigation device;

(4) a server: which provides services for computers, and includes a processor, a hard disk, a memory, a system bus and the like; the server is similar to the general computer in terms of architecture; however, since more reliable services need to be provided, higher requirements are imposed on the processing capability, stability, reliability, security, extensibility, manageability and the like of the device; and

(5) another electronic device having the data interaction function.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. A part of or all of the modules may be selected according to actual needs to achieve the objectives of the solutions of the embodiments. Persons of ordinary skill in the art may understand and implement the present disclosure without paying any creative effort.

According to the above embodiments of the present invention, a person skilled in the art may clearly understand that the embodiments of the present invention may be implemented by means of hardware or by means of software plus a necessary general hardware platform. Based on such understanding, portions of the technical solutions of the present disclosure that essentially contribute to the related art may be embodied in the form of a software product, the computer software product may be stored in a storage medium, such as a ROM/RAM, a magnetic disk, a CD-ROM and the like, including several instructions for causing a computer device (a personal computer, a server, or a network device) to perform the various embodiments of the present disclosure, or certain portions of the method of the embodiments.

Finally, it should be noted that the foregoing embodiments are merely used to illustrate the technical solutions of the present disclosure rather than limiting the technical solutions of the present disclosure. Although the present disclosure is described in detail with reference to the foregoing embodiments, persons of ordinary skill in the art should understand that they may still make modifications to the technical solutions described in the foregoing embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A split television implementation method, applied to a split television, comprising the following steps performed by a processor and a playing device of the split television:
processing, by the processor, a received video signal, such that the video signal is converted into a first signal capable of being transmitted in a wireless manner;
sending, by the processor, the first signal obtained via conversion to the playing device in a wireless transmission manner;
acquiring, by the playing device, the first signal sent in the wireless transmission manner; and
processing, by the playing device, the acquired first signal, and converting the first signal into a video signal capable of being displayed on a display screen.

2. The method according to claim 1, wherein the processing, by the processor, a received video signal, such that the video signal is converted into a first signal capable of being transmitted in a wireless manner comprises:
sending the received video signal, such that the video signal is capable of being converted into the first signal that is transmittable in a wireless manner; and
receiving the video signal, and performing conversion for the received video signal to convert the video signal into the first signal.

3. The method according to claim 2, wherein the performing conversion for the received video signal to convert the video signal into the first signal specifically comprises:
converting the received video signal with a resolution of 4K or 2K into a first signal adopting the high-speed wireless local area network (WLAN) protocol and using a 60 GHz frequency band.

4. The method according to claim 1, wherein the processing, by the playing device, the acquired first signal to convert the first signal into a video signal capable of being displayed on a display screen comprises:
sending the acquired first signal, such that the first signal is capable of being converted into the video signal; and
receiving the acquired first signal, and performing conversion for the acquired first signal to convert the first signal into the video signal.

5. The method according to claim 4, wherein the performing conversion for the acquired first signal to convert the first signal into the video signal specifically comprises:
converting the received first signal adopting the high-speed wireless local area network (WLAN) protocol and using a 60 GHz frequency band into a video signal with a resolution of 4K or 2K.

6. The method according to claim 5, wherein the converting the received first signal adopting the high-speed WLAN protocol and using a 60 GHz frequency band into a video signal with a resolution of 4K or 2K specifically comprises:
converting the received first signal adopting the high-speed WLAN protocol and using the 60 GHz frequency band into a digital signal in a universal serial bus (USB) format;
convening the digital signal obtained via conversion in a USB format into a digital signal in a display port (DP) format;
converting the digital signal obtained via conversion in the DP format into a digital signal in a high-definition multimedia interface (HDMI) format; and
converting the digital signal obtained via conversion in the HDMI format into the video signal with a resolution of 4K or 2K.

7. A split television, comprising:
a video signal processing module, configured to process a received video signal, such that the video signal is converted into a first signal capable of being transmitted in a wireless manner;
a sending module, configured to send the first signal obtained via conversion by the video signal processing module to a playing device in a wireless transmission manner; an acquiring module, configured to acquire the first signal obtained via conversion by the video signal processing module, sent by the sending module in the wireless transmission manner; and
a first signal processing module, configured to process the first signal acquired by the acquiring module, and convert the first signal into a video signal capable of being displayed on a display screen.

8. The split television according to claim 7, wherein the video signal processing module comprises:
a video signal sending module, configured to send the received video signal, such that the video signal is capable of being converted into the first signal that is transmittable in a wireless manner; and a video signal converting module, configured to receive the video signal sent by the video signal sending module, and perform conversion for the received video signal to convert the video signal into the first signal.

9. The split television according to claim 8, wherein the first signal processing module comprises:
a first signal sending module, configured to send the first signal acquired by the acquiring module, such that the first signal is capable of being converted into the video signal; and a first signal converting module, configured to receive the first signal sent by the first signal sending module, and perform conversion for the first signal to convert the first signal into the video signal.

10. The split television according to claim 9, wherein the first signal converting module comprises:
a local area network converting module, configured to convert the first signal adopting the high-speed wireless local area network (WLAN) protocol and using a 60 GHz frequency band, received by the video signal sending module, into a digital signal in a universal serial bus (USB) format;
a USB format converting module, configured to convert the digital signal obtained via conversion by the local area network converting module in a USB format into a digital signal in a display port (DP) format;
a DP format converting module, configured to convert the digital signal obtained via conversion by the USB format converting module in the DP format into a digital signal in a high-definition multimedia interface (HDMI) format; and
an HDMI format converting module, configured to convert the digital signal obtained via conversion by the DP format converting module in the HDMI format into a video signal with a resolution of 4K or 2K.

11. An electronic device, comprising:
a playing device and at least one processor; and
a memory communicably connected to the at least one processor; wherein
the memory stores instructions executable by the at least one processor, wherein, the instructions, when being executed by the at least one processor, cause the at least one processor to:
processing a received video signal, such that the video signal is converted into a first signal capable of being transmitted in a wireless manner;
sending the first signal obtained via conversion to the playing device in a wireless transmission manner;
the playing device is capable of:
acquiring the first signal sent in a wireless transmission manner; and
processing the acquired first signal, and converting the first signal into a video signal capable of being displayed on a display screen.

12. The electronic device according to claim 11, wherein the processing, by the processor, a received video signal, such that the video signal is converted into a first signal capable of being transmitted in a wireless manner comprises:
sending the received video signal, such that the video signal is capable of being converted into the first signal that is transmittable in a wireless manner; and
receiving the video signal, and performing conversion for the received video signal to convert the video signal into the first signal.

13. The electronic device according to claim 12, wherein the processing acquired the first signal, and converting the first signal into a video signal capable of being displayed on a display screen comprises:
sending the acquired first signal, such that the first signal is capable of being converted into the video signal; and
receiving the first signal sent by the first signal sending module, and performing conversion for the first signal to convert the first signal into the video signal.

14. The electronic device according to claim 13, wherein the receiving the first signal, and performing conversion for the first signal to convert the first signal into the video signal comprises:
convening the received first signal adopting the high-speed wireless local area network (FLAN) protocol and using a 60 GHz frequency band into a digital signal in a universal serial bus (USB) format;
converting the digital signal in the USB format obtained via conversion into a digital signal in a display port (DP) format;
converting the digital signal in the DP format obtained via conversion by a USB format converting module into a digital signal in a high-definition multimedia interface (HDMI) format; and
converting the digital signal in the HDMI format obtained via conversion by a DP format converting module into a video signal with a resolution of 4K, or 2K.
